(19) United States
(12) Patent Application Publication
(10) Pub. No.: US 2015/0264496 A1
(43) Pub. Date: Sep. 17, 2015

(54) METHOD FOR PRODUCING HEARING AID FITTINGS

(71) Applicants: Oticon A/S, Smorum (DK); Bernafon AG, Berne (CH)

(72) Inventors: Monika Bertges REBER, Heitenried (CH); Gabriel KURE, Smorum (DK); Karsten Bo RASMUSSEN, Smorum (DK)

(73) Assignees: Bernafon AG, Berne (CH); Oticon A/S, Smorum (DK)

(21) Appl. No.: 14/656,240

(22) Filed: Mar. 12, 2015

(30) Foreign Application Priority Data
Mar. 13, 2014 (EP) 14159435.8

(51) Int. Cl. H04R 25/00

(52) U.S. Cl. CPC H04R 25/652

(57) ABSTRACT

A method for producing a custom-fit hearing device is disclosed. The method for producing a custom-fit hearing device comprises the step of scanning the hearing aid user's ear(s). The method comprises the step of scanning the outer ear of at least one of the user's ears and/or at least a region of the skull bone of the hearing aid user and providing data obtained during scans.

### FIELD OF DISCLOSURE

The present disclosure generally relates to a method for producing a custom-fit hearing device. The present disclosure more particularly relates to a method for providing a custom-fit hearing device that may include a custom-fit dome, earmould and tube (or wires) of a hearing device.

### PRIOR ART

In hearing device, and especially hearing aid, fittings the (thin) tubes or wires used do not have the perfect size or fit for the user of the hearing device. This is particular a challenge when dealing with receiver-in-the-ear (RITE) and behind-the-ear (BTE) type hearing devices.

Individually bendable tube systems are available on the market today. It is, however; a challenge that manually bending of the tubes is required, since the bending procedure requires experienced personal and is time consuming compared to the alternative—to use a standard tube.

Moreover, when a tube needs to be replaced with a new one, the bending procedure needs to be replicated the exact same way, which is difficult in practice. Bearing in mind that the tubes for RITE hearing devices are thermal bend, it is critical if a bend does not fit the user of the hearing device, because a bend cannot be fixed if it has not been bend incorrectly.

Also some hearing aid and cochlear implant types operate a microphone placed inside the pinna area. Here a custom fit may well help in assuring optimal placement of such a microphone.

Thus, there is need for a way of providing a custom-fit hearing aid in an easier manner that reduces or even eliminates these drawbacks of the prior art.

It is an object of the present disclosure to provide an improved way of providing a custom-fit hearing aid. It is a further object to provide an alternative to the prior art.

### SUMMARY

The objects of the present disclosure may be achieved by a method as defined in claim 1 and by a hearing device as defined in claim 12. Preferred embodiments are defined in the dependent sub claims and explained in the following description and illustrated in the accompanying drawings.

The method according to the disclosure is a method for producing a custom-fit hearing device, which method comprises the step of scanning the hearing aid user's ear(s). The method comprises the step of scanning the outer ear of at least one of the user's ears and/or at least a region of the skull bone of the hearing aid user and providing data from the conducted scans. Here, preferably the region of the skull bone is at least the area where a wire or connector, e.g. a tube, is to be placed, i.e. a connector connecting a behind-the-ear part with an in-the-ear part. The term ‘region of the skull bone’ is meant to designate the area of the head where the wire or connector is to be located, but may also include or be at least part of the ear canal.

Hereby it is possible to provide an improved way of providing a custom-fit hearing aid by means of the scan(s).

In the present context, a “hearing device” refers to a device, such as e.g. a hearing aid, a listening device or an active ear-protection device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears.

A “hearing device” further refers to a device such as an earphone or a headset adapted to receive audio signals electronically, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve and/or to the auditory cortex of the user.

A hearing device may be configured to be worn in any known way, e.g. as a unit arranged behind the ear with a tube leading air-borne acoustic signals into the ear canal or with a loudspeaker arranged close to or in the ear canal, as a unit entirely or partly arranged in the pinna and/or in the ear canal, as a unit attached to a fixture implanted into the skull bone, as an entirely or partly implanted unit, etc.

A hearing device may comprise a single unit or several units communicating electronically with each other.

More generally, a hearing device comprises an input transducer for receiving an acoustic signal from a user's surroundings and providing a corresponding input audio signal and/or a receiver for electronically receiving an input audio signal, a signal processing circuit for processing the input audio signal and an output means for providing an audible signal to the user in dependence on the processed audio signal. Some hearing devices may comprise multiple input transducers, e.g. for providing direction-dependent audio signal processing.

In some hearing devices, the receiver may be a wireless receiver. In some hearing devices, the receiver may be e.g. an input amplifier for receiving a wired signal. In some hearing devices, an amplifier may constitute the signal processing circuit. In some hearing devices, the output means may comprise an output transducer, such as e.g. a loudspeaker for providing an air-borne acoustic signal or a vibrator for providing a structure-borne or liquid-borne acoustic signal. In some hearing devices, the output means may comprise one or more output electrodes for providing electric signals.

In some hearing devices, the vibrator may be adapted to provide a structure-borne acoustic signal transcutaneously or percutaneously to the skull bone. In some hearing devices, the vibrator may be implanted in the middle ear and/or in the inner ear.

In some hearing devices, the vibrator may be adapted to provide a structure-borne acoustic signal to a middle-ear bone and/or to the cochlea.

In some hearing devices, the vibrator may be adapted to provide a liquid-borne acoustic signal in the cochlear liquid, e.g. through the oval window. In some hearing devices, the output electrodes may be implanted in the cochlea or on the inside of the skull bone and may be adapted to provide the electric signals to the hair cells of the cochlea, to one or more hearing nerves and/or to the auditory cortex.

A “hearing system” refers to a system comprising one or two hearing devices, and a “binaural hearing system” refers to a system comprising one or two hearing devices and being adapted to cooperatively provide audible signals to both of the user's ears.

Hearing systems or binaural hearing systems may further comprise “auxiliary devices”, which communicate with the hearing devices and affect and/or benefit from the function of the hearing devices. Auxiliary devices may be e.g. remote controls, remote microphones, audio gateway devices, mobile phones, public-address systems, car audio systems or music players. Hearing devices, hearing systems or binaural hearing systems may e.g. be used for compensating for a hearing-impaired person's loss of hearing capability, augmenting or protecting a normal-hearing person's hearing capability and/or conveying electronic audio signals to a person.

The method according to the disclosure is a method for producing a custom-fit hearing device that requires custom-fit of one or more components including a dome, an earmould, a tube or a wire. The hearing device may by way of example be a RITE or a BTE type hearing device.

The step of scanning at least one of hearing aid user's ears may include any suitable scanning technique including standard camera and video techniques.

The step of scanning at least one of hearing aid user's ears may include scanning the ear canal of at least one of hearing aid user's ears.

The method comprises the step of scanning the outer ear of at least one of the user's ears. The scanning the outer ear of at least one of the user's ears may be carried out by using any suitable scanning technique including standard camera and video techniques. Standard camera and video techniques may include two-dimensional images and three-dimensional images.

The method may scan at least a region of the skull bone of the hearing aid user. The scanning the skull bone of the hearing aid user may be carried out by using any suitable scanning technique.

The method comprises the step of providing data from the conducted scans.

By providing data from the conducted scanning(s) it is possible to apply the data from conducted scan(s) to provide a custom-fit hearing device.

It may be an advantage that the method comprises the step of producing a dome or a mould on the basis of the data from conducted by scans.

Hereby it is possible to provide a user of a hearing device with a custom-fit dome or mould.

Production of a dome or a mould on the basis of the data from conducted scans may be carried out by using any suitable manufacturing method. It may be an advantage that the data from the conducted scan(s) are sent directly to a producer of the dome or a mould.

It may be an advantage that the data from the conducted scan(s) and calculated data from the conducted scan(s) are saved and stored for later use.

It may be beneficial that the method comprises the step of producing a tube or a wire on the basis of date from the conducted scans.

It may be advantageous that method comprises the step of storing the data from conducted scan(s) in a device that comprises means for representing the data from conducted scan(s) for an audiologist.

Hereby it is possible for an audiologist to have visual access to the representations of data from conducted scan(s) and hereby to use the representations to select the most appropriate strategy (e.g. selection of earmould/dome type).

Device may be a computer having a display unit such as a computer screen.

It may be an advantage that method comprises the step of generating at least one image, preferably at least one three-dimensional image of the hearing device and the dome/earmould and tube/wire arranged on the user.

Hereby it is possible to have a preview and see if standard components fit the user. Moreover it is possible to make decisions regarding the choice of components (fittings) to the hearing device e.g. by an audiologist.

It may be beneficial that method comprises the step of comparing the at least one image with a number of predefined components.

The comparison may be carried out by providing images of a number of predefined components. These components may be standard components.

Hereby it becomes easier to make a correct decision regarding the choice of fittings (including their shape and size) e.g. for the audiologist.

It may be an advantage that the method comprises the step of calculating one or more positions at which a directional microphone can be arranged, on the basis of the scan(s) and at least one predefined optimization criterion.

Hereby it is possible to provide a hearing device with custom-fit arrangement of directional microphone. In this way the hearing device can be individually optimised.

It may be advantageous that the method comprises the step of providing three-dimensional images of the outer ear and/or the skull bone of the user.

Hereby it is possible to provide custom-fit fittings including earmoulds and domes that fit to the outer ear and/or the skull bone of the user.

It may be an advantage that the method comprises the step of providing at least one magnetic resonance imaging (MRI) scan.

Hereby it is possible to provide a non-invasive imaging method to obtain high resolution anatomic pictures of tissue and organs.

It may be beneficial that the method comprises the step of providing at least one x-ray based computer tomography (CT) scan.

Hereby it is possible to provide good imaging of bone structures.

It may be an advantage that the method comprises the step of providing at least one scan by using at least one optical sensor.

Hereby it is possible to provide two-dimensional images or three-dimensional images.

The hearing aid according to the disclosure is a hearing device provided by using a method according to one of the claims 1-11.

The hearing aid according to the disclosure is a custom-fit hearing aid that is individually adapted to meet user specific requirements.

It may be an advantage that the hearing device comprises a dome or an earmould produced on the basis of the data from conducted scans.

Hereby it is possible to provide a dome or earmould that is custom-fit and is individually adapted to meet user specific requirements.

It may be beneficial that the hearing device comprises a tube or a wire having a length that is custom-fit on the basis of data from conducted scans.

Hereby it is possible to provide tubes and wires that fit the requirements of the user of the hearing device.

The wire may be provided between the casing of a hearing device and the corresponding receiver of the hearing device.

It may be advantageous that the hearing device comprises a tube or a wire having a predefined number of custom-fit bend(s) that are custom-fit on the basis of the data from conducted scans.

Hereby it is possible to provide a hearing device and matching tube(s)/wire(s) that meet individual requirements of a single user.

The method according to the disclosure may include scanning the ear canal. Scanning of the ear canal may be conducted by using any suitable scanning technique, including three-dimensional video techniques.

The method according to the disclosure may include creation of a digital representation of any of the following structures: the ear canal, the outer ear and the skull bone.

Scanning of the ear canal may be carried out by capturing images and applying an algorithm to combine the images into a three-dimensional scan.

It is possible to apply a hand-held scanner. The data from conducted scanning may be sent electronically e.g. by computer to the hearing aid manufacturer anywhere in the world instantaneously.

The method according to the disclosure provides valuable information to the manufacturer of domes, earmoulds, tubes and wires. The method may provide digital imaging that eliminates errors caused by casting material shrinkage.

The method according to the disclosure makes it possible to deliver a more comfortable experience without the use of casting materials for the hearing aid user. The method may provide an electronic three-dimensional image containing data about the unique details of an ear canal.

### DESCRIPTION OF THE DRAWINGS

The method and apparatus will become more fully understood from the detailed description given herein below. The accompanying drawings are given by way of illustration only, and thus, they are not limitative of the present claims. In the accompanying drawings:

FIG. 1 a) shows a close-up view of an ear canal being scanned;

FIG. 1 b) shows a close-up view of a hearing aid user being scanned;

FIG. 2 a) shows a schematically view of a scan of a first hearing aid user;

FIG. 2 b) shows another schematically view of a scan of the first hearing aid user;

FIG. 2 c) shows a schematically view of a scan of a second hearing aid user;

FIG. 2 d) shows another schematically view of a scan of the second hearing aid user;

FIG. 3 a) shows a perspective view of a RITE hearing device;

FIG. 3 b) shows a perspective view of another RITE hearing device;

FIG. 3 c) shows a schematically view of a number of power domes and a micro mould;

FIG. 3 d) shows a schematically view of a number of different earpieces;

FIG. 4 a) shows a perspective view of a BTE hearing device;

FIG. 4 b) shows a close-up view of the earmould of the hearing device shown in FIG. 4 a) and

FIG. 5 shows user of a custom-fit hearing device according to the disclosure and

FIG. 6 is a schematic representation of an optimal pinna microphone placement.

### DETAILED DESCRIPTION OF THE DRAWINGS

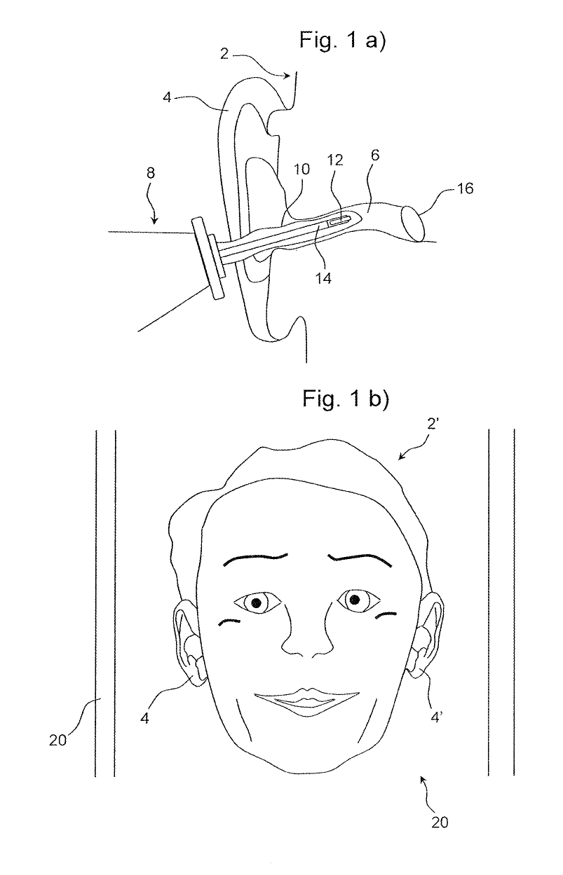

Referring now in detail to the drawings for the purpose of illustrating preferred embodiments of the present disclosure, different scanning procedures according to the disclosure are illustrated in FIG. 1.

FIG. 1 a) illustrates a schematically view of an ear canal scanning conducted on a hearing aid user 2. An ear canal scanner 8 is inserted into the ear canal 6 of the right ear 4 of the hearing aid user 2. The ear canal scanner 8 comprises a flexible membrane 10 that covers a camera 12 and rod member 14. The camera 12 is provided at the distal end of the rod member 14. The camera 12 is an optical probe capable of scanning the sides of the ear canal 6.

The scanning of the ear canal 6 may include detection of the ear anatomy in the form of three-dimensional images and video datasets.

The optical probe 12 is arranged in front of the ear drum 16, however, it is preferred the scanning includes images of the distal portion of the ear canal 6.

FIG. 1 b) illustrates a close-up view of a hearing aid user 2′ being scanned in a scanning device 20. The head of the hearing aid user 2′ has been inserted into the cavity 18 of the scanning device 20.

The scanning device 20 may scan the right ear 4, the left ear 4′ as well of the ear canals and the skull bone of the hearing aid user 2′.

The scanning device 20 may include a magnetic resonance imaging (MRI) scanning device. MRI is a non-invasive imaging method to obtain high resolution anatomic pictures of tissue and organs.

The scanning device 20 may include an x-ray based computer tomography (CT) scanning device. Compared to a MRI scanning device, a CT scanning device has good capability of imaging of bone but poor capability in imaging of soft tissue.

The scanning device 20 may include several optical cameras and means for calculating a number of 3-dimensional surface points from the images. These points can be applied to create a 3-dimensional impression surface of the outer ears 4, 4′ including the concha bowl.

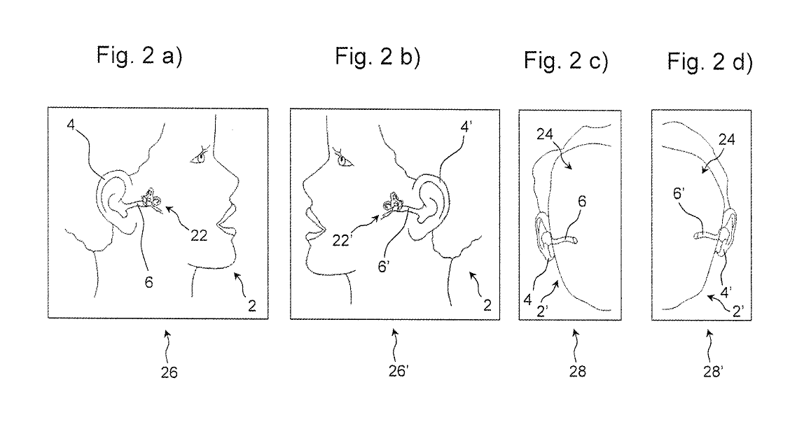

FIG. 2 a) illustrates a schematically view of a scan 26 of a first hearing aid user 2. The scan 26 shows the right ear canal 6, the right outer ear 4 of the hearing aid user 2 as well as the right inner ear 22 of the hearing aid user 2.

FIG. 2 b) illustrates a schematically view of a scan 26′ of the first hearing aid user 2 seen from the left side. The scan 26 shows the left ear canal 6, the left outer ear 4′ of the hearing aid user 2 as well as the left inner ear 22 of the hearing aid user 2.

FIG. 2 c) illustrates a schematically view of a scan 28 of a second hearing aid user 2′. The scan 28 shows the right side of the head of the second hearing aid user 2′. The scan 28 shows the right ear canal 6, the right outer ear 4 and the skull bone 24 of the second hearing aid user 2′.

FIG. 2 d) illustrates a schematically view of another scan 28 of the second hearing aid user 2′. The scan 28′ shows the left side of the head of the second hearing aid user 2′. The scan 28′ shows the left ear canal 6′, the left outer ear 4′ and the skull bone 24 of the second hearing aid user 2′.

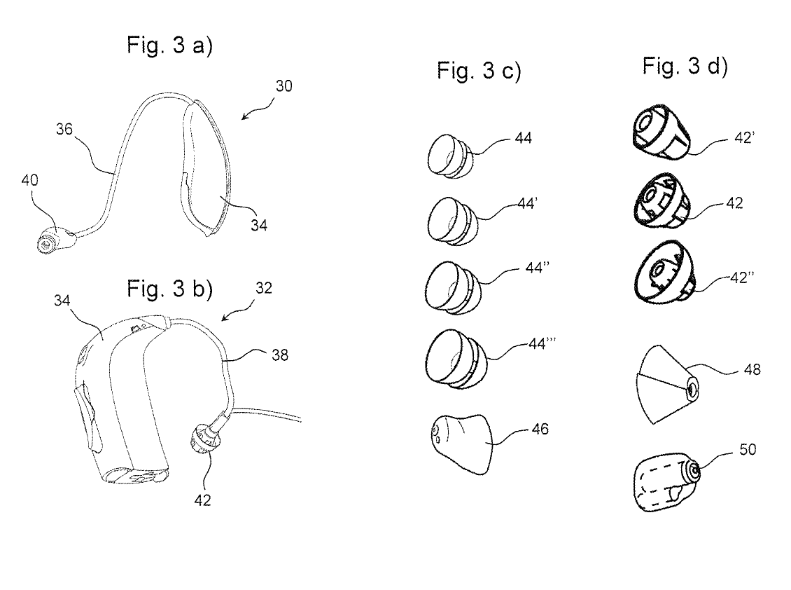

FIG. 3 a) illustrates a perspective view of a RITE hearing device 30 according to the disclosure. The hearing device 30 comprises a casing 34 and a receiver 40 connected to the casing through a tube 36. The receiver 40 of the hearing device 30 is configured to receive a dome or a mould for insertion in the ear canal of the user of the hearing device 30.

FIG. 3 b) illustrates a perspective view of another RITE hearing device 32 according to the disclosure. The hearing device 32 comprises a casing 34 and a receiver connected to the casing through a thin tube 38. An open dome 42 has been attached to the receiver.

The hearing devices 30, 32 shown in FIG. 3 a) and FIG. 3 b) may be individually adjusted according to user specific requirements related to the anatomy of the ear of the user.

The shape and size of the dome as well as the length of the tube/thin tube may be designed to fit the anatomy of the ear of the user.

Scans of the outer ear, the ear canal and the skull bone of the user, may be used to provide a dome (or a mould) and tubes that fit the user. Accordingly, by applying the method according to the disclosure it is possible to provide a hearing device 30, 32 and matching tubes 36, 38 and domes 42 that meet user specific requirements. The match between anatomy and hearing aid is provided either by custom production/adjustment or by choosing from a range of pre-produced devices according to obtained scanning data.

FIG. 3 c) illustrates a schematically view of a number of power domes 44, 44′, 44″, 44′″ and a micro mould 46. By using the method according to the disclosure it is possible to design and produce a power dome 44, 44′, 44″, 44′″ or a micro mould 46 that fits the ear canal of the user of the hearing device 30, 32.

FIG. 3 d) illustrates a schematically view of a number of open domes 42, 42′, 42″, a plus dome 48 and a custom-fit micro mould 50. By using the method according to the disclosure it is possible to design and produce an open dome 42, 42′, 42″, a plus dome 48 or a custom-fit micro mould 50 that fits the ear canal of the user of the hearing device 30, 32.

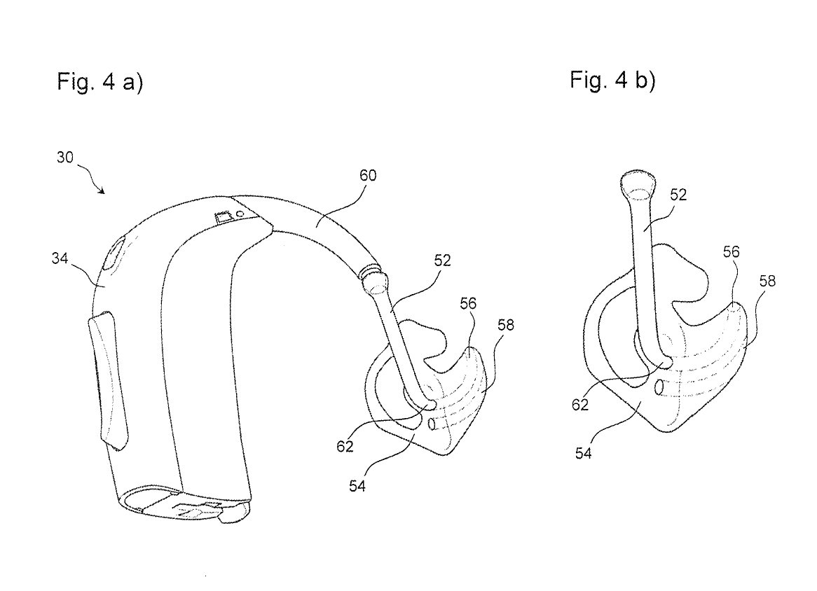

FIG. 4 a) illustrates a schematically perspective view of a BTE hearing device 30 according to the disclosure. The hearing device 30 comprises a casing 34 and a custom-fit earmould 54. A tube 52 is attached to and integrated in the earmould 54. The tube 52 comprises a custom-fit bend 62 and is attached to a sound tube 60 that is attached to the casing 34 of the hearing device 30. The tube 52 ends in a sound outlet 56 extending next to a bend vent 58.

The bend 62 and the geometry and size of the earmould 54 is designed on the basis of scans (see FIG. 2) of the ear of the user of the hearing device 30.

In this way it is possible to provide a hearing aid that fits perfectly into the ear of the user.

FIG. 4 b) illustrates a close-up view of the earmould 54 of the hearing device shown 30 in FIG. 4 a).

The earmould 54 is custom-fit and comprises a tube 52 that is attached to and integrated in the earmould 54. The tube 52 comprises a custom-fit bend 62 and is configured to be attached to a sound tube 60 of the hearing device 30 (see FIG. 4 a). The tube 52 ends in a sound outlet 56 extending next to a bend vent 58.

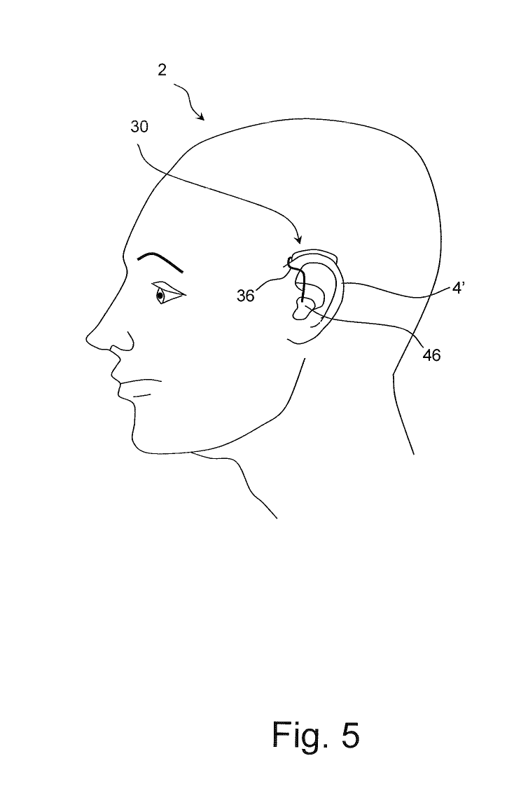

FIG. 5 shows user 2 of a custom-fit hearing device 30 according to the disclosure. The hearing device 30 is a BTE hearing aid provided with a tube 36 that is connected to a micro mould 46 that has been inserted into the left ear′ of the user 2 of a custom-fit hearing device 30. The length of the tube 36 as well as the geometry and size of the micro mould 46 fits the user 2. The tube 36 and micro mould 46 are made on the basis of scans of the user's ear, ear canal and/or skull bone.

Hereby it is possible to provide a hearing device 30 that fits perfectly into the ear 4′ of the user 2.

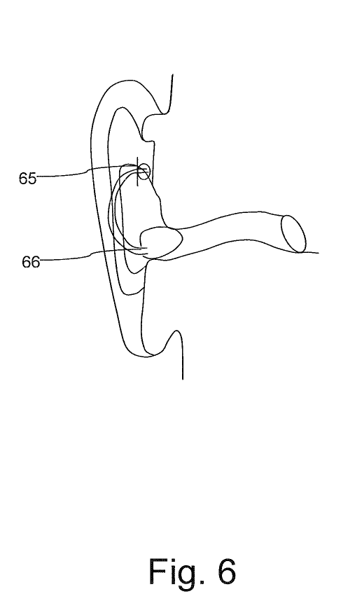

In FIG. 6 the pinna microphone 65 is shown in a schematic view. Such a microphone needs to be placed in a cosmetically attractive way on the device 66 and also from the point of audiology there is an advantageous positioning. The scan data and object data model based on scanning data may help provide an optimised compromise between these two for the user.

### LIST OF REFERENCE NUMERALS

2—Hearing aid user
4, 4′—Ear
6, 6′ Ear canal
8—Ear canal scanner
10—Membrane
12—Camera
14—Rod member
16, 16′—Ear drum
18—Cavity
20—Scanning device
22, 22′—Inner ear
24—Skull bone
26, 26′—Scan
28, 28′—Scan
30—Hearing device
32—Hearing device
34—Casing
36—Tube
38—Thin tube
40—Receiver
42, 42′, 42″—Open dome
44, 44′, 44″, 44′″—Power dome
46—Micro mould
48—Plus dome
50—Custom-fit micro mould
52—Tube
54—Earmould
56—Sound outlet
58—Vent
60—Sound hook
62—Bend
65—Pinna microphone
66—In ear device with pinna microphone

1. A method for producing a custom-fit hearing device, which method comprises the step of scanning hearing device user's ear(s), the method comprises the step of scanning the outer ear of at least one of the hearing device user's ears and/or at least a region of the skull bone of the hearing device user and providing data from the conducted scanning(s).

2. A method according to claim 1, wherein the region of the skull bone of the hearing aid user being scanned includes the area where a tube or a wire is to be positioned.

3. A method according to claim 1, wherein that the method comprises the step of producing a dome or a mould on the basis of the data from conducted scans.

4. A method according to claim 1, the method comprises the step of producing a tube or a wire on the basis of the data from conducted scans.

5. A method according to claim 1, the method comprises the step of storing the data from conducted scan(s) in a device that comprises means for representing the data from conducted scan(s) for an audiologist and the step of generating at least one image, preferably at least one three-dimensional image of the hearing device and the dome or mould and tube or wire arranged on the user.

6. A method according to claim 5, the method comprises the step of comparing the at least one image with a number of predefined components.

7. A method according to claim 1, wherein the method comprises the step of calculating one or more positions at which a directional microphone can be arranged, on the basis of the data from conducted scan(s) and at least one predefined optimization criterion.

8. A method according to claim 1, the method comprises the step of providing three-dimensional images of the outer ear and/or the skull bone of the user.

9. A method according to claim 1, the method comprises the step of providing data from at least one magnetic resonance imaging scan.

10. A method according to claim 1, the method comprises the step of providing data from at least one x-ray based computer tomography scan.

11. A method according to claim 1, the method comprises the step of providing at least data from one scan by using at least one optical sensor.

12. A method according to claim 1, the method comprises the step of choosing at least one hearing aid part from a range of pre-defined parts according to the scanned data.

13. A hearing device provided by using a method according to claim 1.

14. A hearing device according to claim 13, the hearing device comprises a dome or an earmould produced or selected from within a range on the basis of data from conducted scans.

15. A hearing device according to claim 12, the hearing device comprises a tube or a wire having a length that is custom-fit or selected from within a range on the basis of the data from conducted scans.

16. A hearing device according to claim 15, the hearing device comprises a tube or a wire having a predefined number of custom-fit bend(s) that are custom-fit on the basis of date from the conducted scans.

17. A method according to claim 2, the method comprises the step of producing a tube or a wire on the basis of the data from conducted scans.

18. A method according to claim 3, the method comprises the step of producing a tube or a wire on the basis of the data from conducted scans.

19. A method according to claim 2, the method comprises the step of storing the data from conducted scan(s) in a device that comprises means for representing the data from conducted scan(s) for an audiologist and the step of generating at least one image, preferably at least one three-dimensional image of the hearing device and the dome or mould and tube or wire arranged on the user.

20. A method according to claim 3, the method comprises the step of storing the data from conducted scan(s) in a device that comprises means for representing the data from conducted scan(s) for an audiologist and the step of generating at least one image, preferably at least one three-dimensional image of the hearing device and the dome or mould and tube or wire arranged on the user.
